(19) United States
(12) Patent Application Publication
(10) Pub. No.: US 2008/0116617 A1
(43) Pub. Date: May 22, 2008

(54) Method For Manufacturing Sheets Of Agglomerate Material Using Dielectric Heating And Associated Plant

(76) Inventor: Luca Toncelli, Bassano del Grappa (IT)

Correspondence Address: KATTEN MUCHIN ROSENMAN LLP, 575 MADISON AVENUE, NEW YORK, NY, 10022-2585, US

(21) Appl. No.: 10/589,103

(22) PCT Filed: Feb. 3, 2005
(86) PCT No.: PCT/EP05/01058

§ 371 Date: Aug. 10, 2006

(30) Foreign Application Priority Data
Feb. 27, 2004 (IT) TV2004A000019

(51) Int. Cl. B29C 41/46; B29C 67/02

(52) U.S. Cl. 264/444; 425/174.2

(57) ABSTRACT

In a method for manufacturing sheets of agglomerate material comprising in succession a first step involving preparation of a mix by mixing a granulate with an organic binder, a second step involving distribution of the mix inside a tray mould, a third step involving vacuum vibro-compaction in order to obtain a compacted sheet, and a final step involving hardening of the organic binder, an intermediate step involving dielectric preheating of the compacted sheet being introduced between the third vacuum vibro-compaction step and the final hardening step.

This application is the National Stage of International Application No. PCT/EP2005/001058, filed Feb. 3, 2005, which claims the benefit under 35 U.S.C. 119 (a-e) of Italian Application No. TV2004A000019 filed Feb. 27, 2004, which is herein incorporated by reference.

The present invention relates to an improvement in the technology used for manufacturing sheets or tiles of agglomerate material, also known as Bretonstone technology.

This technology envisages a succession of steps, the main ones of which are:
the preparation of a mix obtained by mixing together granulated stone materials together with a binder, generally consisting of organic resins;
the distribution of the mix thus obtained inside a tray mould in a uniform manner so as to obtain a layer of mix with a constant thickness;
compaction of the mix, which is performed under vacuum conditions, by applying a given vibrating movement to the tray containing the layer of mix, thus obtaining a sheet of compacted material;
a step involving hot-hardening or catalysis of the compacted sheets, performed preferably in ovens with heating surfaces inside which the tray moulds are stacked;
   these ovens normally operate at a temperature ranging between 85° C. and 140° C. and preferably between 100° C. and 120° C.

This technology, which is described in EP-A-0 786 325 and is now well-established, allows sheets of agglomerate material with notable mechanical and aesthetic properties to be obtained in an efficient manner.

However, the time required for the hardening step is considerably greater than that of the vacuum vibro-compaction step, causing a number of problems.

In fact, the hardening step envisages a long transitory preheating period (about 8 to 15 minutes depending on the thickness of the sheet and the temperature of the surfaces) which heats the compacted sheet to the temperature for activation of catalysis (normally about 80° C.) and, subsequently, a period (about 6 to 8 minutes) where the compacted sheet remains at the catalysis temperature (about 100° C.). In this connection it must be pointed out that the catalysis reaction is exothermic, so that, after activation thereof, there is a sudden rise in the temperature of the article equivalent to a few tens of degrees.

Owing to the heat conduction coefficient of the mix, which is relatively low, during the abovementioned transitory period, the internal part of the compacted sheet is heated at a later time than the external part.

It is also indispensable that the heating surfaces should have a perfect geometry and that the temperature should be perfectly uniform not only over the whole area of the surfaces but also between one surface and the next: substantial temperature gradients, namely differences in temperature between different zones of the sheet to be hardened, cause unacceptable distortion of the sheet. The catalysis and hardening of the article are in fact accompanied by substantial dimensional shrinkage, so that varying catalysis kinetics in different zones result in non-uniform shrinkage kinetics.

On the other hand, it is of fundamental importance to obtain, as a final result, sheets which are perfectly flat and, therefore, necessarily the increase in temperature during the transitory period must occur in a perfectly uniform manner over the entire surface and possibly throughout the thickness of the sheet.

It should be noted that the overall duration of the hardening step depends to a large extent on the duration of the transitory preheating period which, in turn, is dependant on the thickness of the compacted sheet and its composition. The greater the thickness of the compacted sheet and/or the lower the heat conduction coefficient of the material forming the compacted sheet, the more difficult will be transmission of heat from the outside towards the inside of the sheet, so that heating must be slower and therefore the time required for the transitory period will be greater.

It should be noted now that the duration of the vibro-compaction step is normally about 100 seconds and that the duration of the step involving hardening of the compacted sheet is always greater than 15 minutes and may even be as high as 25 minutes.

Since the catalysis time is therefore about 15 times greater than the time required for vibro-compaction, a hardening station with a capacity—in terms of the number of sheets which it is able to contain—of at least 15 is required. Usually the ovens used have 15-18 compartments, each of which is able to receive a sheet to be hardened.

The ovens used, moreover, are per se fairly complex since, as already commented, during the hardening step, the sheet must be kept at a constant and perfectly uniform temperature. In particular, such ovens have notable dimensions and therefore have negative repercussions on the bulk, the final cost and the running of the plant.

As already mentioned above, when it is required to manufacture sheets of considerable thickness or sheets containing a granulate with a low heat conduction coefficient, the time required for the hardening step is increased considerably.

For example, if it is required to manufacture sheets of agglomerate with a low weight, such as that described in Italian Patent Application No. TV2003A000134 filed on 29 Sep. 2003 in the name of Dario Toncelli (and corresponding to WO-A-2005/030474), it was found that, owing to the low heat transmission coefficient of the expanded granulates which form part of the mix, the time required for hardening increases to even as much as 45 minutes. In such conditions the catalysis oven would assume dimensions and a complexity which are practically unacceptable such that a plant of this kind would be uneconomical.

The object of the invention is therefore that of eliminating the drawbacks mentioned above and in any case ensuring that the construction of a plant is economical even in the case where thicknesses of the sheets to be obtained are considerable or in the case where granulates with a low heat conduction coefficient, such as expanded granulates, are used.

The object is achieved with a method for manufacturing sheets of agglomerate material comprising, in succession:
a first step involving preparation of a mix by mixing inert materials of predetermined particle size with an organic binder,
a second step involving distribution of said mix inside a tray mould so as to form a layer of mix,
a third step involving vacuum vibro-compaction in order to obtain a compacted sheet, and
a fourth step involving hardening of the organic binder by means of heating ovens in order to obtain the final sheet,
   characterized in that an intermediate step involving dielectric preheating of the compacted sheet is introduced between said third vacuum vibro-compaction step and said fourth hardening step for the purpose of reaching a temperature which is a few degrees centigrade below the temperature at which the catalysis of the binder starts in the subsequent final hardening step, the said dielectric preheating making use of electromagnetic radiofrequency waves having a frequency of less than 300 MHz.

It will be easily understood that such a frequency is considerably lower than the frequency utilized in the microwave ovens (2450 MHz) considered in U.S. Pat. No. 3,953,703 in a process for drying a ceramic tape with a volatile solvent and a binder and proposed for obtaining a complete hardening of articles made of a mix of concrete containing epoxy resin in a paper by B. Etmanski and A. K. Bledzki published in Plastverarbeiter, 43 (1992), No. 7, pages 64-66.

In this way the transitory preheating step is performed outside of the catalysis oven, thus reducing substantially the amount of time the sheets to be catalysed spend inside them. There is a reduction in the number of compartments inside the catalysis oven and therefore also in its size and consequently also the complexity of the plant.

In this way the sheet is preheated no longer by means of conduction, transmitting the heat from the heating surfaces of the oven to the said sheet, but also owing to the fact that the heat is generated directly inside the sheet where the direct conversion of the energy from electromagnetic energy to thermal energy occurs.

The efficiency of this type of heating is such as to reduce significantly the preheating time, making it compatible with the vibro-compaction time and ensuring perfectly uniform heating throughout the thickness and over the whole surface, with enormous advantages.

The invention also relates to the associated plant for implementing the method referred to above.

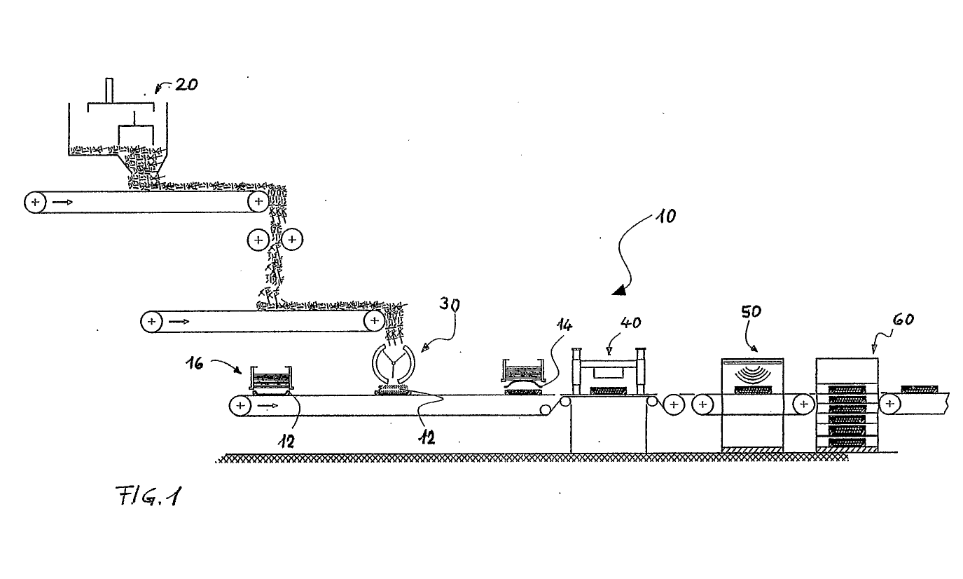

These advantages, together with others, will emerge more clearly from the following detailed description of a plant according to the invention, provided by way of a non-limiting example, with reference to the accompanying drawing in which FIG. 1 is a perspective view of a plant designed in accordance with the present invention.

FIG. 1 denotes overall by 10 a plant for manufacturing sheets of agglomerate material of the type described in Italian Patent No. 1,288,566, corresponding to the above mentioned EP-A-0 786 325. The plant 10 comprises a first station 20 for preparing a mix formed by mixing granulates of different materials, such as natural and non-natural stone materials, together with an organic binder, such as for example polyester or epoxy or acrylic or epoxy vinyl resins.

Thereafter the plant envisages a second station 30 for distribution of the mix inside a tray mould 12 in a uniform manner, so as to obtain a soft layer of mix of substantially constant thickness. The tray mould 12 is removed from a store 16 situated at the front of the plant 10. A sheet 14 of material identical to that (not shown) forming the bottom of the tray mould is deposited on top of the mix distributed inside the tray mould.

The mould 12 enclosing the layer of mix is transferred to a third vacuum vibro-compaction station 40 where it undergoes deaeration by means of a very intense vacuum and then vacuum vibro-compaction by means of application of a pressure with a vibratory movement, thus producing a sheet of compacted material.

According to a fundamental characteristic feature of the present invention, the mould 12 containing the compacted sheet is then transferred to an intermediate station 50 for preheating by means of electromagnetic radiofrequency waves where the compacted sheet is heated and brought rapidly to a temperature slightly below that at which catalysis starts (about 78° C.).

Finally, the mould is introduced inside a conventional catalysis oven 60 consisting of pairs of heated surfaces (at a temperature of about 100-120° C.) onto which the trays with the sheets to be catalysed are inserted, the catalysis reaction taking place there on a support which is perfectly flat.

The intermediate radiofrequency preheating station 50 allows the compacted sheet to be heated in a short time (less than 100 seconds) and in a perfectly uniform manner until the temperature at which catalysis starts is reached. The station 50 may in particular be constructed in the form of a tunnel oven.

In particular the compacted sheet is subjected for a duration of less than 100 seconds to radiofrequency waves having a frequency of less than 300 MHz (maximum limit) and preferably ranging between 25 and 35 MHz. The frequency is chosen so as to ensure an optimum heating efficiency depending on the type of resin and inert material with which the material of the mix is formed.

It should be noted that in this way the generation of the heat is performed directly inside the compacted sheet so that preheating occurs very rapidly and in a uniform manner throughout the thickness of the sheet, without the risk that temperature differences are generated between the outer part and inner part or different zones of the sheet, thus preventing the said sheet from curving or bending.

The preheating time is approximately only 80 seconds and is substantially dependent upon the thickness of the sheet and its composition.

Considering that in conventional plants the overall time required for catalysis varies from a minimum of 15 minutes to a maximum even as high as 45 minutes, as mentioned above, and that most of this time was required in order to heat the sheet slowly and gradually to the catalysis temperature, the enormous advantage achieved is obvious.

In fact the catalysis station according to the present invention is composed of few pairs of heating surfaces and, in the specific case, of only 5 compartments, whereas, in the corresponding conventional plant, the compartments would instead have been 15 in number and even many more in the case where expanded light inert material (granulates) is used.

Within the scope of the corresponding appended claims, other embodiments of the method and of the plant of the present invention can be envisaged.

1. Method for manufacturing sheets of agglomerate material making use of electromagnetic radiofrequency waves having a frequency of less than 300 MHz and comprising, in succession, a first step involving preparation of a mix by mixing together stone materials of predetermined particle size with a binder consisting of organic resins, a second step involving distribution of said mix inside a tray mould so as to form a layer of mix, a third step involving vacuum vibro-compaction in order to obtain a compacted sheet, and a final step involving hardening or catalysis of the binder by means of heating ovens in order to obtain the finished products, characterized in that the said use of electromagnetic radiofrequency waves takes place in an intermediate step between said third vacuum vibro-compaction step and said final hardening step which consists in dielectrically preheating the compacted sheet until it reaches a temperature which is less than 10° C., and preferably less than 5° C., below the temperature at which the catalysis of the binder starts in the subsequent final hardening step.

2. Method according to claim 1, characterized in that the compacted sheet is preheated until it reaches a temperature which is less than 5° C.

3. (canceled)

4. Method according to claim 1, characterized in that, the end of said intermediate preheating step, the compacted sheet reaches a temperature lower than the temperature at which catalysis of the binder starts and preferably ranging of between 75° C. and 78° C.

5. Method according to claim 1, characterized in that it is used for a mix which contains granulates of the expanded type.

6. Plant for manufacturing sheets of agglomerate material using the method according to claim 1 and comprising, in succession, a first station (20) for preparing a mix by mixing a granulate of predetermined particle size with a binder consisting of organic resins, a second station (30) for distributing said mix inside a tray mould (12) so as to form a layer of mix, a third vacuum vibro-compaction station (40) for obtaining a compacted sheet, and a final hardening station (60) comprising at least one heating oven for catalysis of the organic binder so as to obtain the final sheet, characterized in that it also comprises an intermediate station (50) making use of means generating electromagnetic radiofrequency waves at a frequency of less than 300 MHz for preheating said compacted sheet, the said intermediate station (50) being arranged between said third vibro-compaction station (40) and said final hardening station (60).

7. (canceled)

8. Plant according to claim 6, characterized in that said means are adapted to generate electromagnetic waves having a frequency of between 25 and 35 MHz in said intermediate station (50).
